(19) United States
(12) Patent Application Publication
(10) Pub. No.: US 2007/0185956 A1
(43) Pub. Date: Aug. 9, 2007

(54) COMMUNICATION SYSTEM AND METHOD

(76) Inventors: David M. Ogle, Cary, NC (US); Patrick J. O'Sullivan, Dublin (IE); Hugh P. Smyth, Dublin (IE)

Correspondence Address: HOFFMAN, WARNICK & D'ALESSANDRO LLC, 75 STATE ST, 14TH FLOOR, ALBANY, NY, 12207, US

(21) Appl. No.: 11/420,093

(22) Filed: May 24, 2006

(30) Foreign Application Priority Data
Feb. 9, 2006 (GB) 0602631.4

(51) Int. Cl. G06F 15/16

(52) U.S. Cl. 709/204

(57) ABSTRACT

A communication system and method for optimizing a network (or web) conference. A communication system in accordance with an embodiment of the invention includes a network conference server, at least one mail server, a moderator's client device, a plurality of participants' client devices, a network interconnecting the servers and client devices, a network conference application executed by the network conference server, and an email application distributed amongst the mail server and the client devices. The network conference application receives from the moderator's client device a first communication comprising a conference schedule, participant details and conference material and transmits to the email application a second communication comprising a network address, the conference schedule, the participant details and the conference material.

### FIELD OF THE INVENTION

This invention relates to a communication system and method for optimizing a network (or web) conference.

### BACKGROUND OF THE INVENTION

Network conferencing software allows multiple participants (and across locations/time zones) to converge in a shared web conference, where the conference moderator can share their screen and presentation with the other participants. In so doing, individuals converge in one place as an electronic meeting and can collaborate on a presentation or topic. This has benefits to an organisation, in terms of time and cost savings, when individuals avoid attending such meetings in person where they choose to attend electronically.

Conventional network conferencing facilities are challenged by a number of key limitations. Web conferences can be slow due to the number of parallel attendees and the need to refresh each of the attendees with incremental updates as the presentation/screen changes. This can be exacerbated when parallel web conferences on a meeting server are taking place. For example, if there are 50 parallel web conferences with 100 users attending each web conference, and a 51st web conference with only 3 people attending, then those in the 51st web conference will suffer to some extent due to the load implied from the other parallel web conferences, and may be frustrated with a situation where an e-meeting comprising 3 individuals is slow.

In conventional systems, as the number of participants in a meeting increase the response time/refresh time for each of the participants degrades. It is common that a point in time is reached when a moderator has finished with a particular slide and moves on to the next slide even though participants in the meeting have not yet had their local screens refreshed. This can be frustrating for the moderator, as well as the participants.

Known meeting software systems manage updates based on delta and compression, thereby limiting the amount of data/traffic that needs to be sent to each of the participants. Even in so doing, the amount of data transmitted for each screen is stochastic, in some cases it will be large (if the refresh/delta is substantial), and in some cases small (if the delta is little). Even in the situation where the delta is small it is still unnecessarily excessive/expensive. Any ability to optimise the pipe between the network conferencing server and the participants enhances performance, usability, reliability and end user experience.

Web conference systems can include real-time collaboration. This can take the form of instant messaging, shared screens where individuals can collectively edit/modify/update, transfer control and so on. In situations where attendee lists are large the moderator generally chooses to disable collaboration capabilities, thus resulting in a broadcast session. They do so with a view to enhancing performance, as the additional cost of enabling collaboration in such conferences has the cumulative effect of further reducing performance. Likewise, when voice (e.g., Voice over IP) is used in a conference there is an increased bandwidth to facilitate the participants, and this further compounds performance.

Frequently to circumvent performance, usability and reliability problems moderators choose to forward their presentation to the participants in advance of the web conference. In so doing the attendees can choose to try and follow the presentation off-line (not connected or in the conference). This is a poor and limited workaround because the conference servers are designed for individuals to converge and be aware of one another and share data in one place, and there should be one place/person traversing a presentation with all other attendees getting refreshed in real time and in an automated way. Offline synchronisation depends on the moderator remembering to instruct changes in the participants' presentations by voice.

### SUMMARY OF THE INVENTION

The present invention provides a communication system and method for optimizing a network (or web) conference

According to a first aspect of the present invention, there is provided a communication system for delivering a network conference, comprising: a network conference server; at least one mail server; a moderator's client device; a plurality of participants' client devices; a network interconnecting the servers and client devices; a network conference application executed by the network conference server; and an email application distributed amongst the mail server and the client devices, wherein the network conference application receives from the moderator's client device a first communication comprising a conference schedule, participant details and conference material and transmits to the email application a second communication comprising a network address, the conference schedule, the participant details and the conference material.

According to a second aspect of the present invention, there is provided a communication method for delivering a network conference, comprising: receiving at a network conference server a first communication from a moderator's client device, the first communication comprising a conference schedule, participant details and conference material; and transmitting from the network conference server a second communication to an email application, the second communication comprising a network address, the conference schedule, the participant details and the conference material.

According to a third aspect of the present invention, there is provided a computer program product on a computer readable medium comprising instructions for: receiving at a network conference server a first communication from a moderator's client device, the first communication comprising a conference schedule, participant details and conference material; and transmitting from the network conference server a second communication to an email application, the second communication comprising a network address, the conference schedule, the participant details and the conference material.

Owing to the invention, it is possible to provide a communication system that simplifies the creation of a web conference and supports the running of a large number of participants in the network conference without a degradation in the performance of the network conference. In this invention the system and method optimize the presentation layer of a web conference session, with a view to making client side refreshes as close to instantaneous as possible. In so doing, the bandwidth and processing savings created will increase performance, usability, reliability and user experience.

Advantageously, the system comprises multiple mail servers and the email application is arranged to transmit a third communication to one or more mail servers according to the participant details in the second communication, the third communication comprising the network address, the conference schedule and the conference material. The participant details will define those persons that are invited to the network conference, who may accept or decline their invitation to the network conference. In a simple system, the participant details will be a list of email addresses of the potential participants to the network conference. When the email application is transmitting the third communication to each participant it is more efficient to send single copies of the third communications to each mail server to which one or more participants are attached. In many situations multiple participants will use the same mail server.

In one embodiment each participant client device is arranged, when accessing the third communication, to store the conference material on the client device. In an alternative embodiment, each participant client device is arranged, when accessing the third communication, to generate a fourth communication accepting the network conference and correspondingly to store the conference material on the client device.

The conference material, which may comprise a file of a common format such as Microsoft PowerPoint, is preferably downloaded to the client device, a PC for example, that the participant will use to interface with the web conference when it is run. The material can be downloaded as soon as a participant accesses the email (or calendar entry) that comprises the invitation to the web conference, or can be downloaded if, and only if, they accept the invitation to the network conference. By having the material for the web conference directly on their local machine, each participant, when they are actually in the web conference, only needs to receive a relatively small amount of data from the web conference server.

Preferably, the email application is further arranged to transmit the fourth communication to the network conference server. The fourth communication indicates acceptance of the user's participation in the network conference. This can be sent back to the moderator who has original created the network conference, but it can also, in an advantageous embodiment of the system, be sent back to the network conference server. This allows the network conference server to update information concerning those participants who have accepted the conference and so forth. For example, the network conference server can be further arranged to maintain an accessible data file comprising those participants for whom the network conference server has received respective fourth communications. This file, which could be accessed by potential participants prior to acceptance, allows those potential participants to see who has accepted attendance at the future network conference.

Advantageously, the network conference application is further arranged to receive from the moderator's client device an update communication comprising an update file and is further arranged to transmit to the email application a participant update communication including the participant details and update material. The structure of the communication system supports a simple and efficient updating of the network conference material that was originally generated by the moderator. This material, which was transmitted to the network conference server and then sent by that server to the email application, can be updated. The moderator can generate an update file and send that to the network conference server. This can then be propagated by the server through the email application to the participants.

### BRIEF DESCRIPTION OF THE DRAWINGS

Embodiments of the present invention will now be described, by way of example only, with reference to the accompanying drawings.

FIG. 1 is a schematic diagram of a communication system.

FIG. 2 is a schematic diagram of the communication system of FIG. 1, with some elements removed, for ease of understanding.

FIG. 3 is a schematic diagram of a portion of the communication system of FIG. 1.

FIG. 4 is a flowchart of a method of operating a communication system.

### DETAILED DESCRIPTION OF THE INVENTION

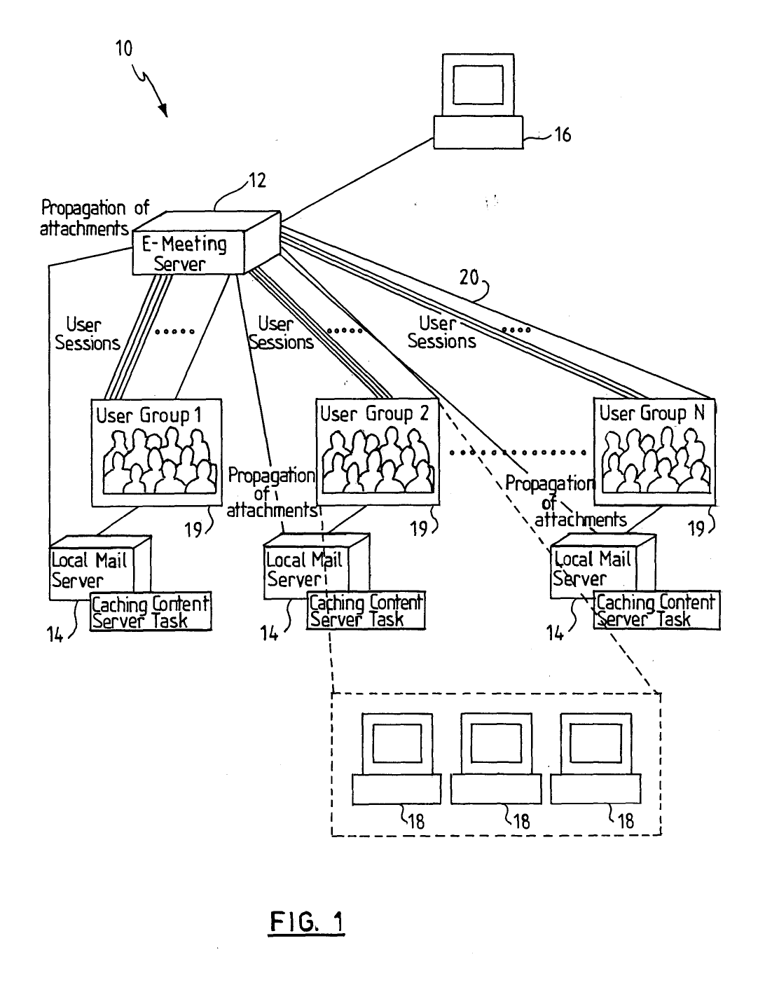

A communication system 10 is shown in FIG. 1. The communication system 10 is for delivering a network conference and includes a network conference server 12, a plurality of mail servers 14, a moderator's client device 16, and a plurality of participants' client devices 18. The client devices 18 can be considered to form user groups 19 that are each associated with a respective local mail server 14. For ease of understanding, three client devices 18 are shown as being in User Group 2, but in reality each user group 19 will have a very large number of associated client devices 18, running into the many hundreds in most situations.

A network 20 interconnects the servers 12,14 and client devices 16,18. The network 20 will, in most practical embodiments of the communication system 10, comprise a combination of local networks and wide area public networks such as the Internet. For example, each client device 18 will connect to a local mail server 14, and in many cases that connection will be via a private intranet.

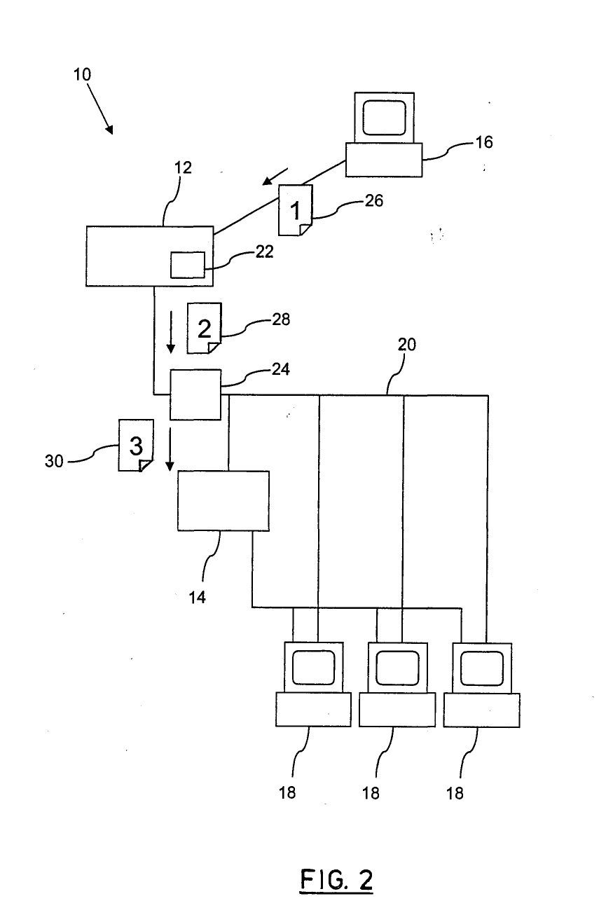

FIG. 2 shows a detail of the communication system 10 of FIG. 1 with some components removed for clarity of understanding. The network conference server 12 is shown connected to the moderator's client device 16, to a single mail server 14 and to three participant client devices 18, via the network 20 (which may be the Internet). The mail server 14 is also connected to the three participant client devices 18 via a local network. Only a single mail server 14 is shown for simplicity.

The network conference server 12 executes a network conference application 22, which can be accessed by any client device 16,18 via the network 20. This network conference application 22 is used to initiate network conferences, and manages the material that is to be presented in the conference, and ensures synchronisation of the material shown to the participants via their respective client device 18. The network conference application 22 will assign a network address to the proposed network conference, which is the location to which the participant client devices 18 will be directed to take part in the network conference.

An email application 24 is distributed amongst the mail servers 14 and the client devices 16 and 18. For ease of understanding, the email application 24 is shown as a separate unit, but it will be understood by those skilled in the art that the client devices 18 (and indeed the moderator's device 16) will run email clients that form part of the overall email system 24, with server components being run by the email servers 14.

When a moderator wishes to initiate a network conference, the network conference application 22 is arranged to receive from the moderator's client device 16 a first communication 26. The web conference moderator (the meeting creator) creates a network conference and identifies the participants. The moderator creates the web conference by interfacing with the network conference application 22, which interaction generates the first communication 26 that comprises a conference schedule (the proposed time and date of the web conference), participant details (who is to be invited) and conference material (one or more files).

Once the network conference application 22 has received the first communication 26 and processed that communication 26, then it is arranged to transmit to the email application 24 a second communication 28, which comprises a network address (for example a URL where the web conference will be located), the conference schedule, the participant details and the conference material.

The communication system 10 includes multiple mail servers 14 and the email application 24. The email application 24 transmits a third communication 30 to one or more of the mail servers 14 following receipt of the second communication 28. The choice of those mail servers 14 that receive the third communication 30 is according to the participant details in the second communication 28. To this extent, the third communication 30 will be sent to each mail server 14 that is associated with a client device 18 of a participant included in participant details in the original communication 26 that initiated the whole process.

In FIG. 2, the third communication 30 is shown as being transmitted to the illustrated mail server 14, as in this example, all three client devices 18 belong to participants for the network conference. The third communication 30 comprises the network address of the future network conference, the conference schedule and the conference material, and is routed to the mail servers 14 of the invitees' client devices 18. At this stage in the process, the conference material has been routed to every mail server 14 that serves a client device 18 of a participant.

Once a potential participant has accessed their email communications from their client device 18 to their local mail server 14, then they will access the third communication 30 that is stored on the mail server 14. The communication system 10 could be configured to use the calendar function of the email application 24, effectively receiving from the web conference server 12 a communication 28 that creates a calendar entry, and the third communication 30 is therefore a calendar invitation to the potential participants, which includes the conference material.

In the communication system 10, the potential participants who have accepted the invitation to the network conference, will have forwarded (passively) to them the conference material (e-meeting presentation and attachment material) for the subsequent network conference. The web conference presentation and attachment material are automatically (and passively as a background task) routed to the mail servers 14 in a shared but proprietary secure store. The reason this needs to be secure is that there may be multiple web conferences, and individuals invited to one should not have the ability to see material from another.

In this regard the mail servers 14 are being used as a caching content server for the web conference e-meeting presentation and attachment material. A caching server task is run on each mail server 14 (as shown in FIG. 1) on the basis that this extends an existing infrastructure that already addresses routing and propagation of email content. Once this has been completed each attendee has local access to the presentation content.

FIG. 1 shows the distribution to 1 to N user groups 19, with separate mail servers 14 for each group 19, with advance propagation of meeting materials to each of these caching content servers (running on the local mail servers 14).

Once the potential participants have indicated that they wish to attend the scheduled web conference, then the action of accepting the invitation generates a fourth communication. The fourth communication indicates acceptance of the network conference and triggers the storing of the conference material on the respective client device 18.

The email application 24 is arranged to transmit the fourth communication to the network conference server 12. The network conference server 12 is arranged to maintain an accessible data file comprising those participants for whom the network conference server 12 has received respective fourth communications. This allows users of the communication system 10 to ascertain who will be attending a web conference that has been scheduled by the communication system 10.

Before any web conference takes place, the communication system 10 can support modification of the moderator's material that has been transmitted through the communication system 10. The moderator's client device 16 can generate an update communication comprising an update file which is received by the network conference application 22 run by the network conference server 12. The network conference server 12 is arranged to transmit to the email application 24 a participant update communication including the participant details and update material, which is then propagated through the communication system 10 by the email application 24 to those mail servers 14 that have attached client devices 18 of participants to the future network conference.

Individuals attending the web conference have a passive validation that confirms to the network conference server 12 that they have the presentation material available locally, and that they have access to these. This validation will form the basis of a modified client-server interaction and user contract for the duration of the web conference.

At the point when a participant attends the network conference the e-meeting presentation and attachment material for the e-meeting are already cached locally on each user's client device 18. Local caching is preferred in the event that the mail server 14 has a failure.

Other methods of accessing the conference material are possible. For example, the material may remain on the local mail server 14 when a participant accepts the invitation to the network conference, and only be cached locally on their client device 18 when they actually perform the validation at the start of the web conference. The reason for not doing advance propagation to each individual user is that this limits propagation to those users that actually attend, and this is decided at the point in time that the user authenticates.

An alternative method of handling the conference material is to keep that material on the local mail server 14 and not to cache it on each participant's client device 18. In this case, the user can access the materials directly through accessing the mail server 14.

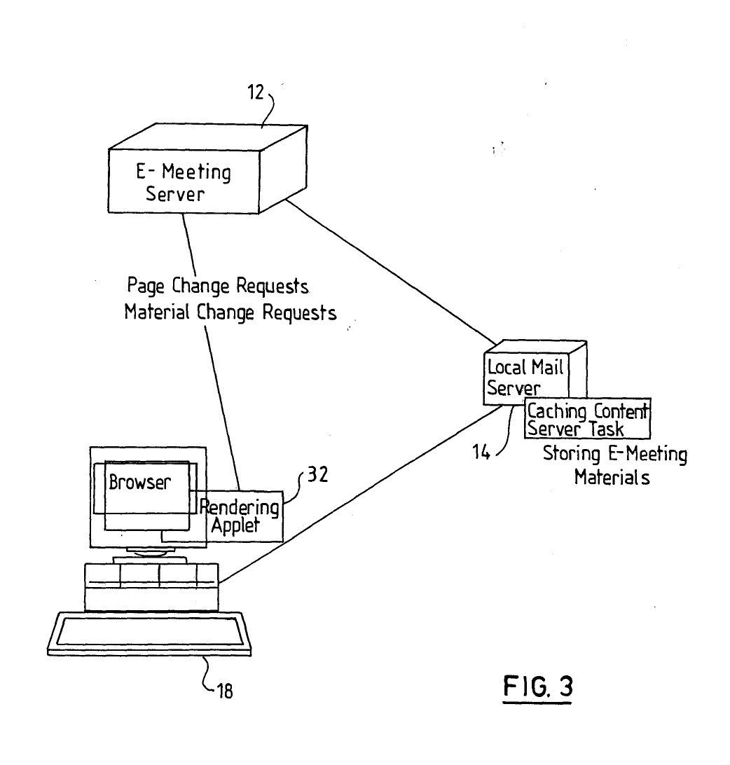

Once authentication has occurred and the user has validated that a local copy of the moderator's materials are available then a local (to the user's client device 18) rendering applet is used to control the user's interaction with the network conference. FIG. 3 shows an example of a client device 18 which is running a rendering applet 32. The rendering applet 32 is a component being executed by the client device 18 that permits interpretation and visualization of the e-meeting presentation and attachment material through understanding of the file format and content.

The rendering applet 32 takes responsibility for requesting from the network conference server 12 which material should be currently viewed and which page of any attachment is the current page. An XML handshake takes place in which this data is communicated to all user client devices 18 participating in the meeting who have validated that they have a local copy of the materials and an ability to render these locally. The only exchange between the network conference server 12 and client device 18 is which presentation/filename/attachment is being viewed, and what page is currently being observed on the server side. This is much lighter/thinner in comparison with the data being transferred today in conventional web conferencing systems.

The rendering applet 32 is also listening to server side page change requests, which in turn get communicated as light XML based directives to the client device 18 in the form of “switch to page N”, where N is the page that the moderator has moved to, on their client device 16.

In the event that the user does not have access to the data locally then the conventional e-Meeting content provision process apply—in other words, the user survives the e-meeting session as a conventional user and benefits from updates from the server by way of delta/page/etc. In the event that a user loses his local cache information (due to a network failure, corruption, etc.) then the user fails over to surviving the remainder of the e-meeting session as a conventional e-meeting attendee, and benefits from updates from the server by way of delta/page/etc.

A communication transaction can be arranged to take place some minutes before the meeting is scheduled to begin such that an integrity check is performed to validate that the propagated meeting content is in synchronisation with the actual materials in the e-meeting (to address changes/updates that may have been generated by the moderator). In the preferred embodiment of the communication system 10 changes made by the moderator get automatically propagated at the point of save/complete.

In general any propagation of material will be scheduled for“quiet time”, such as at night, but this will occur at some point in time before the meeting is scheduled to commence and some time after the moderator has committed the meeting and attachments. The server side store (on the mail server 14) is secured in terms of access and represents a cache for network conference content that gets automatically deleted when the e-conference is complete, and has“fetch” only access from the perspective of the participants.

To protect the direct network conference server 12 to client device 18 propagation of the web conference presentation and attachment material, the presentation and attachment material on the user's desktop is stored in a cache that gets deleted after the web conference has completed. As stated, the preferred embodiment is a central store in a shared mail server 14 to limit propagation to users that actually attend the meeting.

If the conference gets cancelled then a process is executed that deletes propagated material to remote caching content servers or where directly propagated to users. The act of propagation of e-the attachments directly to the user is one that greatly reduces the bandwidth, latency, performance and reliability problems for users in web conferences. In the above embodiment, page transitions are now communicated textually (XML), and move the processing and rendering challenge to the client via a rendering applet.

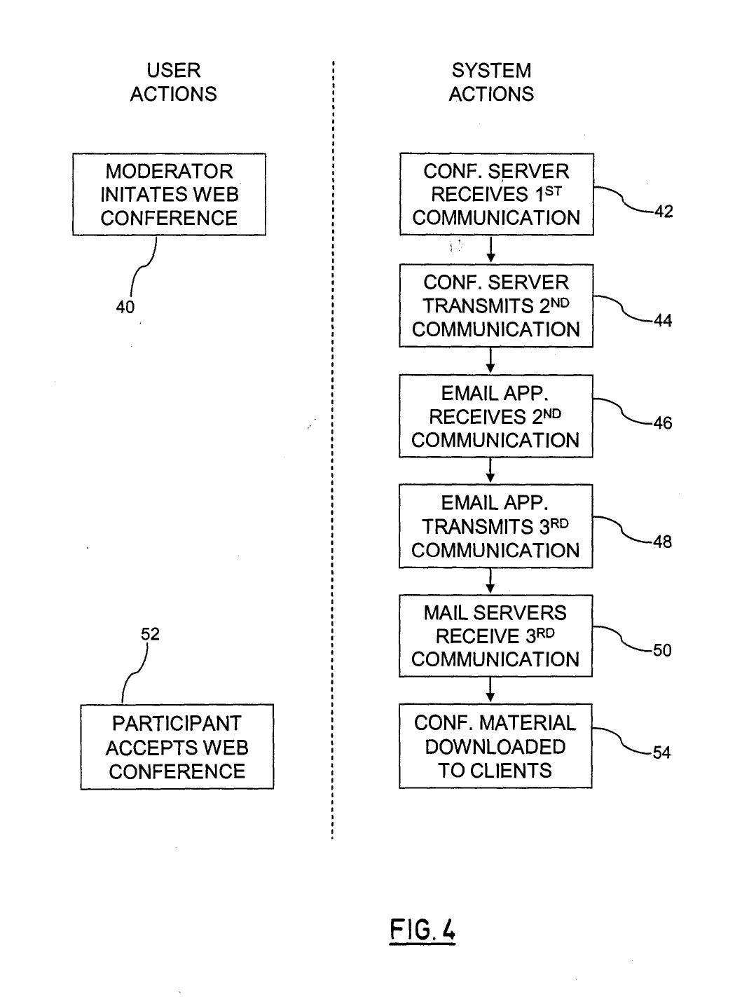

FIG. 4 summarises the method carried out following initiation of a web conference by a moderator, which forms the action 40 in FIG. 4. At step 42, the network conference server 12 receives the first communication 26 from the moderator's client device 16, which communication defines the web conference, the participants and the material to be used in the conference.

At step 44 the network conference server 12 transmits the second communication 28 which is received by the email application 24 at step 46. The email application 24 then transmits the third communication 30 to the mail servers 14 at step 50. Then, in the preferred embodiment, when a user at step 52 accepts participation in the network conference, then the conference materials are downloaded to the participant's client device 18, at step 54.

The foregoing description of the preferred embodiments of this invention has been presented for purposes of illustration and description. It is not intended to be exhaustive or to limit the invention to the precise form disclosed, and obviously, many modifications and variations are possible.

1. A communication system for delivering a network conference, comprising:
a network conference server;
at least one mail server;
a moderator's client device;
a plurality of participants' client devices;
a network interconnecting the servers and client devices;
a network conference application executed by the network conference server; and
an email application distributed amongst the mail server and the client devices,
wherein the network conference application receives from the moderator's client device a first communication comprising a conference schedule, participant details and conference material and transmits to the email application a second communication comprising a network address, the conference schedule, the participant details and the conference material.

2. A system according to claim 1, wherein the system comprises multiple mail servers and the email application transmits a third communication to at least one of the mail servers according to the participant details in the second communication, the third communication comprising the network address, the conference schedule and the conference material.

3. A system according to claim 2, wherein each participant client device, when accessing the third communication, stores the conference material on the participant client device.

4. A system according to claim 2, wherein each participant client device, when accessing the third communication, generates a fourth communication accepting the network conference and correspondingly to store the conference material on the participant client device.

5. A system according to claim 4, wherein the email application transmits the fourth communication to the network conference server.

6. A system according to claim 5, wherein the network conference server maintains an accessible data file comprising those participants for whom the network conference server has received respective fourth communications.

7. A system according to claim 1, wherein the network conference application receives from the moderator's client device an update communication comprising an update file and transmits to the email application a participant update communication including the participant details and update material.

8. A communication method for delivering a network conference, comprising:
receiving at a network conference server a first communication from a moderator's client device, the first communication comprising a conference schedule, participant details and conference material; and
transmitting from the network conference server a second communication to an email application, the second communication comprising a network address, the conference schedule, the participant details and the conference material.

9. A method according to claim 8, further comprising:
transmitting a third communication from the email application to at least one mail server according to the participant details in the second communication, the third communication comprising the network address, the conference schedule and the conference material.

10. A method according to claim 9, further comprising:
accessing the third communication at a participant client device and storing the conference material on the client device.

11. A method according to claim 9, further comprising:
generating a fourth communication at a participant client device following accessing of the third communication, the fourth communication to accept the network conference; and
storing the conference material on the client device.

12. A method according to claim 11, further comprising:
transmitting the fourth communication from the email application to the network conference server.

13. A method according to claim 12, further comprising:
maintaining an accessible data file at the network conference server, the data file comprising those participants for whom the network conference server has received respective fourth communications.

14. A method according to claim 8, further comprising:
receiving at the network conference application an update communication from the moderator's client device, the update communication comprising an update file; and
transmitting from the network conference server a participant update communication to the email application, the participant update communication including the participant details and update material.

15. A computer program product on a computer readable medium, comprising instructions for:
receiving at a network conference server a first communication from a moderator's client device, the first communication comprising a conference schedule, participant details and conference material; and
transmitting from the network conference server a second communication to an email application, the second communication comprising a network address, the conference schedule, the participant details and the conference material.

16. A computer program product according to claim 15, further comprising instructions for:
transmitting a third communication to at least one mail server according to the participant details in the second communication, the third communication comprising the network address, the conference schedule and the conference material.

17. A computer program product according to claim 15, further comprising instructions for:
receiving a fourth communication at the network conference server, and for maintaining an accessible data file at the network conference server, the data file comprising those participants for whom the network conference server has received respective fourth communications.

18. A computer program product according to claim 15, further comprising instructions for:
receiving at the network conference application an update communication from the moderator's client device, the update communication comprising an update file; and
transmitting from the network conference server a participant update communication to the email application, the participant update communication including the participant details and update material.
